(19) United States
(12) Patent Application Publication
(10) Pub. No.: US 2020/0320591 A1
(43) Pub. Date: Oct. 8, 2020

(54) FEEDBACK ANALYTICS AND IMPROVED TEST MANAGEMENT

(71) Applicant: Charter Communications Operating, LLC, St. Louis, MO (US)

(72) Inventors: Vinayak Raghavendra Rao, Parker, CO (US); Vivek Nandalike, San Jose, CA (US)

(21) Appl. No.: 16/372,681

(22) Filed: Apr. 2, 2019

(51) Int. Cl. G06Q 30/02; G06Q 30/00; G06F 8/77; G06F 11/36

(52) U.S. Cl. CPC G06Q 30/0282; G06F 11/366; G06F 8/77; G06Q 30/016

(57) ABSTRACT

According to one configuration, a test management resource receives feedback pertaining to use of one or more customer service applications that provide one or more services to respective customers. Via processing of the feedback, and in furtherance of providing test management, the test management resource identifies a respective topic to which the received feedback pertains. In one example implementation, the test management resource maps a respective topic (as identified from analysis of the feedback) to a test matter to which the feedback pertains; the test matter is pertinent to testing attributes of the customer service application as specified by the feedback. The test management further produces test management information in accordance with the received feedback. The test management resource or corresponding business entity uses the test management information to manage implementation attributes (such as modification, prioritization, etc.) of one or more test matters depending on received feedback.

### BACKGROUND

It is well known that businesses have moved towards providing customer support to their corresponding customers via on-line self-service digital platforms (such as via web sites and mobile applications). For example, more than ever before, via mobile communication devices, customers are able to perform on-line functions such as paying bills, signing up for different services, changing user settings, setting up communication preferences, submitting service requests, troubleshooting equipment such as modems, phones, etc. These on-line digital platforms benefit both the customers and the company.

Unfortunately, these customer service applications provided by respective business to perform different functions are prone to failure or defects. For example, a selectable option on a displayed menu for a given customer service application may not provide a respective user the ability to perform a desired function such as pay a bill, sign up for different services, change user settings, etc. This often results in the customer having to call a respective service provider and speak to a representative to address any matters.

### BRIEF DESCRIPTION OF EMBODIMENTS

This disclosure includes the observation that current test platform implementations require substantial manpower and corresponding efforts to ensure that each aspect of respective customer service applications function properly. To this end, embodiments herein include novel ways of managing testing operations to more efficiently improve customer service applications.

More specifically, one embodiment herein includes a test management resource (such as implemented via hardware, software, or a combination of hardware and software). During operation of the applications by the end customers, the test management resource receives feedback pertaining to use of one or more customer service applications that provide one or more respective customer services to multiple customers. Via processing of the feedback, the test management resource identifies a respective topic (such as subject matter) to which the received feedback pertains. The test management resource uses the identified respective topic as a basis to map the received feedback to a test matter pertinent to testing attributes of the customer service application as specified by the feedback.

For example, if the feedback indicates a defect such as a particular function of a customer service application that is failing or has issues, the test management resource identifies a particular test matter (a.k.a., test case) to which the feedback pertains. The test management resource produces test management information in accordance with the received feedback and identified test issue. A corresponding business entity controls implementation (management) of the test matter depending on the received feedback.

Note that test matters may be pre-existing, currently in development, or in need of being created for one or more respective defects associated with a customer service application.

As further discussed herein, controlling management of a respective test matter can include any suitable one or more functions such as prioritization of one or more existing or newly created test matters, further development or modification of one or more existing test matters, creation of one or more new test matters to address corresponding identified issues associated with customer service applications, and so on.

Note that the feedback regarding defects of the one or more customer service applications as described herein can be generated and received from any suitable one or more resource. For example, in one embodiment, the feedback (text, audio, etc.) is received from and/or generated by each of the multiple customers using the respective customer service applications. In such an instance, the feedback includes or is based on reviews provided by each of the multiple customers.

In one embodiment, the feedback represents negative reviews from users using the multiple different customer service applications. Additionally, or alternatively, note that the feedback can be received from other sources such as usage logs (production logs, failure logs, etc.), social media communications, etc., associated with one or more customers using the customer service applications.

In accordance with further embodiments, the multiple customers using the multiple customer service applications include users of one or more social networks. The test management resource receives at least a portion of the feedback from messages communicated between users in the social network; the social media messages pertain to use of the multiple different customer service applications. In one embodiment, the messages indicate shortcomings associated with one or more of the customer service applications and are used as a basis to produce the test management information.

In accordance with further embodiments, the test management resource receives input from the multiple customers; the input includes text-based reviews of the multiple different customer service applications and features therein. The test management resource as described herein can be configured to include one or more filters operable to filter the text-based reviews to produce the feedback pertinent to the different test matters. Filtering of the feedback provides a more accurate mapping of the feedback to an appropriate one or more test matters (such as test routines) used to test corresponding one or more customer service applications and features therein.

In one embodiment, the feedback includes or specifies any suitable information such as attributes of the multiple customer service applications, shortcomings (such as failures, defects, issues, etc.) associated with the multiple different customer service applications, etc.

In accordance with further embodiments, to identify an existing or new test matter to which the feedback pertains, the test management resource converts raw received customer feedback into word vector feedback (such as based on Term Frequency-Inverse Document Frequency). As previously discussed, the test management resource can be configured to filter the received feedback prior to conversion into the word vector feedback indicating a respective topic to which the feedback pertains. Via the word vector feedback, the test management resource classifies the feedback based on the respective topic as specified by the word vector feedback.

In accordance with still further embodiments, the test management resource receives first feedback and second feedback such as from different users. Assume that the first feedback is pertinent to a first test routine applicable to testing a feature (feature #1 such as bill pay) customer service application of the multiple different customer service applications; assume that the second feedback is pertinent to a second test routine applicable to testing a second feature (feature #2 such as equipment troubleshooting) of the multiple features of customer service applications. In one embodiment, the test management resource ranks an order of implementing and/or modifying (such as creating, updating, fixing, etc.) the first test routine and the second test routine depending on how many of the multiple customers indicate a fault (shortcoming) associated with the first feature (feature #1) of the customer service application and how many of the multiple customers indicate a fault (shortcoming) associated with the second feature (feature #2) of the customer service application.

In accordance with a summary embodiment as described herein, the test management resource receives feedback from multiple customers; the feedback pertains to use of the multiple different features of the customer service applications, which provide services to the multiple customers over respective network connections (and communication interfaces such as browsers) through which the multiple customers access and use the multiple customer service applications. As previously discussed, the test management resource classifies the different received feedback based on a respective topic (such as issue, defect, failure, etc.) to which the received feedback pertains. The test management resource then maps the respective topic to a corresponding test routine operable to test the topic.

In accordance with further embodiments, the test management resource (or other suitable resource) can be configured to generate test management information such as to schedule an update to the corresponding test routine based on an amount of the feedback pertaining to the topic to which the corresponding test routine pertains. For example, if the amount of negative feedback for a first identified defective feature (first software function)/and corresponding test routine is low, and a second identified defective feature (software function)/and corresponding test routine is high, then the test management resource can be configured to generate test management information indicating that the second identified feature/test routine needs to be fixed or updated sooner than the first identified feature/test routine. In such an instance, using the producing test management information, a business entity schedules the second defective test routine for updating prior to updating the first identified defective test routine.

Embodiments herein are useful over conventional techniques. For example, in contrast to conventional techniques of developing and implementing testing of one or more customer services applications and features therein based on manual efforts, this disclosure provides improved test coverage, decreased human error, and reduced overall costs associated with testing and verification of corresponding customer service platforms (such as customer service applications) via a unique processing of feedback, mapping to pertinent one or more test routines (new or existing) associated with the customer service applications, and identifying corresponding test routines, prioritizing the test routines based off the feedback received from end customers and also identifying test coverage gaps if any (i.e., absence of test routines or defective test routines to test for the feedback received)

Note that any of the resources as discussed herein can include one or more computerized devices, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon to facilitate testing management and implementation. The instructions, when executed by computer processor hardware, cause the computer processor hardware (such as one or more co-located or disparately processor devices or hardware) to: receive feedback, the feedback pertaining to use of multiple different customer service applications that provide services to the multiple customers; classify the feedback based on a respective topic to which the received feedback pertains; utilize the classified feedback to identify which of multiple test routines the classified feedback pertains, the multiple test routines operable to test attributes of the multiple different customer service applications and features therein; and modify/manage/update/prioritize the test routines depending on the received feedback.

Another embodiment includes a computer readable storage medium and/or system having instructions stored thereon to facilitate testing management and/or implementation. The instructions, when executed by computer processor hardware, cause the computer processor hardware (such as one or more co-located or disparately processor devices or hardware) to: receive feedback pertaining to use of a customer service application, the customer service application providing customer service to multiple customers; identifying a respective topic to which the received feedback pertains; map the respective topic to a test matter to which the feedback pertains, the test matter pertinent to testing attributes of the customer service application as specified by the feedback; and produce test management information in accordance with the received feedback.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of customer service application testing management. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a network environment and testing management according to embodiments herein.

FIG. 2 is an example diagram illustrating mapping of customer service application feedback to corresponding test cases according to embodiments herein.

FIG. 3 is an example diagram illustrating mapping of feedback to corresponding test cases according to embodiments herein.

FIG. 4 is an example diagram illustrating implementation of a test management resource according to embodiments herein.

FIG. 5 is an example diagram illustrating test management operations according to embodiments herein.

FIG. 6 is an example diagram illustrating analysis of feedback and corresponding test management operations according to embodiments herein.

FIG. 7 is an example graph illustrating feedback grouped by cluster according to embodiments herein.

FIG. 8 is an example diagram illustrating example computer architecture operable to execute one or more operations according to embodiments herein.

FIG. 9 is an example diagram illustrating a method according to embodiments herein.

FIG. 10 is an example diagram illustrating a method according to embodiments herein.

FIG. 11 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

In accordance with general embodiments, a test management resource receives feedback pertaining to use of one or more customer service applications that provide one or more services to respective customers. Via processing of the feedback, and in furtherance of providing test management, the test management resource identifies a respective topic to which the received feedback pertains. In one example implementation, the test management resource maps a respective topic (as identified from analysis of the feedback) to a test matter (or test plan) to which the feedback pertains; the test matter is pertinent to testing attributes of the customer service application as specified by the feedback. The test management further produces test management information in accordance with the received feedback. In one embodiment, the test management resource or corresponding business entity uses the test management information to manage implementation (such as modification, prioritization, etc.) of one or more test matters depending on received feedback.

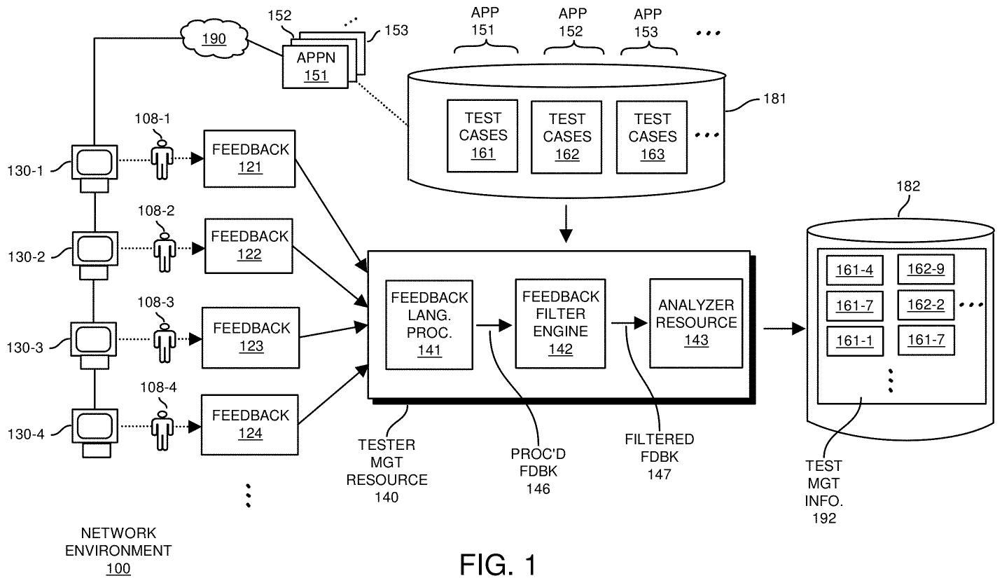

Now, more specifically, FIG. 1 is an example diagram illustrating a network environment and testing management according to embodiments herein.

As shown, network environment 100 includes test management resource 140, repository 181, repository 182, and communication devices 130 such as computer systems.

In this example embodiment, tester management resource 140 includes feedback language processor 141, feedback filter engine 142, and analyzer engine/machine learning algorithm 143. Repository 181 stores test plans or test cases 161, 162, 163, etc., associated with corresponding testing of customer service applications 151, 152, 153, etc. Repository 182 stores test management information 192 associated with the test cases 161, 162, 163, etc.

As further shown, network environment 100 further includes computer devices and corresponding display screens 130-1, 130-2, 130-3, 130-4, etc., operated by respective users 108-1, 108-2, 108-3, 108-4, etc.

Note that any of the resources (such as test management resource 140, computer devices 130, etc.) as discussed herein can be executed via computer hardware, executing computer software, or a combination of computer hardware and executed computer software (such as one or more executed computer instructions).

In one embodiment, the users 108 operate the respective communication devices 130 (such as mobile communication devices, smart phones, personal devices, etc.) to use customer services provided by respective customer service applications and features therein 151, 152, 153, etc., served by one or more server resources.

For example, assume that the user 108-1 operating communication device 130-1 communicates over network 190 to a respective application server to retrieve and display a corresponding graphical user interface associated with customer service application 151. In this example embodiment, the user 108-1 uses the graphical user interface associated with the accessed customer service application 151 to perform one or more functions such as pay bills online, monitor a user account, subscribe to new subscription services, etc. In one embodiment, based on the user experience of the user 108-1 using the application 151, the user 108-1 then provides feedback 121 indicating one or more problems (such as issues, defects, shortcomings, etc.) associated with using a respective application 151. Note that the user 108-1 can access any of the customer service applications and provide feedback for each application.

Further in this example embodiment, assume that the user 108-2 operating communication device 130-2 also communicates over network 190 to an application server to retrieve (such as a webpage) and display a corresponding graphical user interface of application 151 on a respective display screen of the communication device 130-2. In a similar manner as previously discussed, the user 108-2 uses the application 151 to perform one or more functions such as pay bills online, monitor a user account, subscribe to new services, etc. In one embodiment, based on the user experience of using the selected application 151, the user 108-2 then provides feedback 122 indicating one or more problems (such as issues, defects, shortcomings, etc.) associated with using a respective application 151. Note that the user 108-2 can access any of the customer service applications and provide feedback for each application.

User 108-3 operating communication device 130-3 also communicates over network 190 to an application server to display corresponding graphical user interface of application 152 on a respective display screen of the communication device 130-3. The user 108-3 uses the retrieved application to perform one or more functions such as pay bills online, monitor a user account, subscribe to new services, etc. In one embodiment, based on the user experience of using the application 152, the user 108-3 then provides feedback 123 indicating one or more problems (such as issues, defects, shortcomings, etc.) associated with using a respective selected application 152. The user 108-2 can access any of the customer service applications and provide feedback for each application.

Assume that the user 108-4 operating communication device 130-4 also communicates over network 190 to an application server to display corresponding graphical user interface of application 152 on a respective display screen of the communication device 130-4. The user 108-4 uses the retrieved application to perform one or more functions such as pay bills online, monitor a user account, subscribe to new services, etc. In one embodiment, based on the user experience of using the application 152, the user 108-4 then provides feedback 124 indicating one or more problems (such as issues, defects, shortcomings, etc.) associated with using a respective application (such as one or more of applications 151, 152, 153, etc.).

Test management resource 140 receives the feedback 121, 122, 123, 124, associated with each of the customer service applications 151, 152, 153, etc.

Note that the feedback as described herein can be generated and received from any suitable one or more source. For example, as previously discussed, the feedback (text, audio, etc.) can be received from and/or generated by each of the multiple customers (users 108) using the respective customer service applications 151, 152, 153, etc. In such an instance, the feedback includes or is based on reviews (such as text or audio) provided by each of the multiple customers.

In one embodiment, the feedback represents negative reviews from users using the multiple different customer service applications.

Additionally, or alternatively, note that the feedback received by the test management resource 140 can be received from other sources such as usage logs (production logs, failure logs, etc.) associated with use of a respective customer service application, social media communications, etc.

Thus, the feedback can include or specify any suitable information such as attributes of the multiple customer service applications, shortcomings (such as failures, defects, issues, etc.) associated with the multiple different customer service applications, etc.

In accordance with further embodiments, the test management resource 140 as described herein filters the received feedback (such as text-based reviews) to produce the processed feedback 146 pertinent to the different test matters associated with customer service applications.

As further shown, feedback filter engine 142 filters the received processed feedback 146 to produce filtered feedback 147. In one embodiment, filtering of the processed feedback 146 facilitates a more accurate mapping of the received feedback 121, 122, 123, 124, etc., to an appropriate one or more test cases (such as test routines, set of test software instructions, testing code, testing plan, etc.) used to test corresponding one or more customer service applications and corresponding identified defects.

More specifically, in one embodiment, to identify a test matter to which the received feedback pertains, the test management resource 140 can be configured to implement feedback filter 141 that converts raw received customer feedback (such as text-based type of feedback 121, 122, 123, 124, etc., or unstructured data) into word vector feedback or more structured data (such as based on implementing Term Frequency-Inverse Document Frequency or other suitable processing).

Via the analyzer resource 143, the test management resource maps the filtered feedback 147 (indicating customer service application defects) to a corresponding topic. The topic (subject matter) indicates the corresponding one or more test cases in repository 181 to which the received feedback pertains.

Note that the test matters or test cases 161, 162, etc., to which the feedback pertains may be pre-existing, currently in development, or in need of being created for one or more respective defect associated with a customer service application.

As indicated by the test management information 192 produced by the test management resource 140, analyzer resource 143 can be configured to perform any suitable one or more functions such as prioritization of one or more existing or newly created test matter, identification of a need to further development or modification of an existing test matter, creation of a new test matter (or open order) to address an identified issue, and so on.

In one embodiment, the test management resource 140 (or other suitable resource such as a business entity) uses the generated test management information 192 to perform an operation such as schedule an update to the corresponding test routine based on an amount of the feedback pertaining to the topic to which the corresponding test routine pertains. For example, if the amount of negative feedback for a first identified defective test routine is low, and negative feedback for a second identified defective test routine is high, then the test management resource 140 (or business entity using the test management information 192) may schedule the second defective test routine for updating/test execution prior to updating/executing of the first identified defective test routine.

Accordingly, a magnitude of the feedback indicates which test cases need to be updated/executed first.

These and additional embodiments of using generated test management information 192 are further discussed herein.

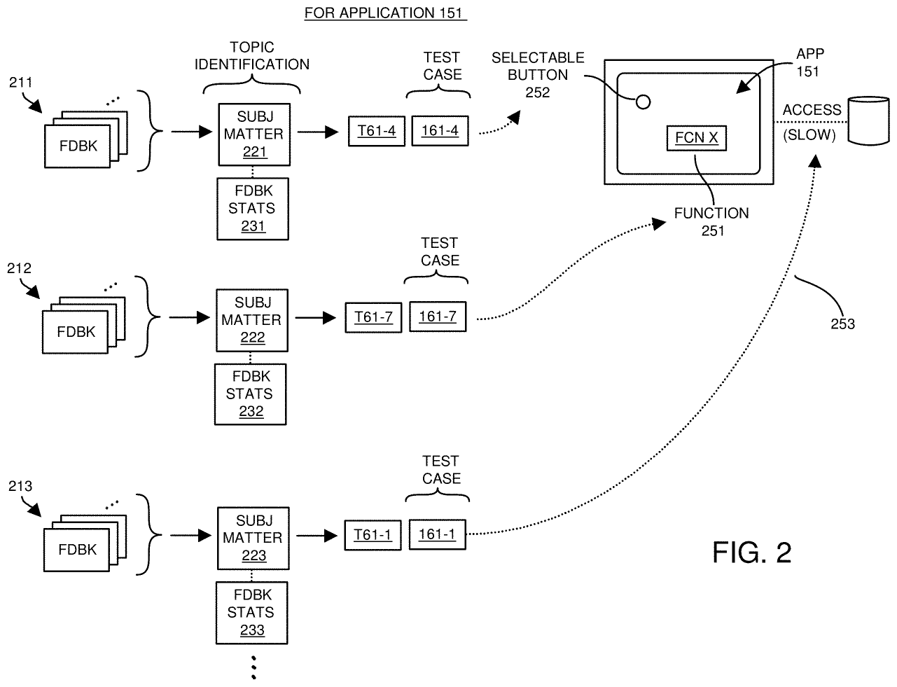

FIG. 2 is an example diagram illustrating mapping of customer service application feedback to corresponding test cases according to embodiments herein.

In this example embodiment, the test management resource 140 receives set of feedback 211 such as filtered feedback from multiple users providing feedback associated with customer service application 151.

As previously discussed, the test management resource 140 implements the analyzer resource 143 to determine a respective subject matter 221 to which the set of feedback 211 pertains.

As further shown, in this example embodiment, based on feedback 211, in addition to identifying that the set of feedback 211 pertains to subject matter 221 (a first particular topic) the test management resource 140 produces corresponding feedback statistics 231 including information such as i) how many of the corresponding users 108 experiences a failure associated with the respective application 151, ii) a particular type of failure associated with application 151, iii) the time of the failure associated with application 151, iv) type of computer device used by the user during a failure associated with application 151, etc. Any of this information can be used as a basis to determine management of a corresponding customer service application or test plans.

In accordance with further embodiments, the test management resource 140 maps the corresponding subject matter 221 (such as word vector form of respective text-based feedback) specified by the set of feedback 211 to topic T61-4 assigned to test case 161-4, which addresses testing of the issue (topic) as identified by feedback 221. In other words, assume that the subject matter 221 indicates failure of selectable button 252 associated with customer service application 151 (such as a webpage). In this example embodiment, the test management resource 140 identifies that the set of feedback 211 pertains to a particular topic T61-4 (such as defect associated with selectable button 252 of the application 151) addressed by the test case 161-4 (such as test routines, set of test software instructions, testing code, testing plan, etc., used to test the identified defect) because test case 161-4 pertains to testing of the selectable button 252.

As further shown, the test management resource 140 implements the analyzer resource 143 to determine a respective subject matter 222 to which the set of feedback 212 pertains.

Yet further in this example embodiment, in addition to identifying that the set of feedback 212 pertains to subject matter 222, based on further processing of the received set of feedback 212, the test management resource 140 produces corresponding feedback statistics 232 including information such as how many of the corresponding users 108 experiences a failure associated with the respective application 151, a particular type of failure associated with application 151, the time of the failure associated with application 151, type of computer device used by the user during a failure associated with application 151, etc.

In this example embodiment, assume that the test management resource 140 maps the corresponding subject matter 222 (such as word vector form of respective text-based feedback) to topic T61-7 assigned to test case 161-7, which is assigned to test the defect (such as failure of function 251 and corresponding inability to pay a bill) indicated by the subject matter 222. Test case 161-7 (such as test routines, set of test software instructions, testing code, testing plan, etc., used to test the identified defect) is used to test the functionality associated with the function 251.

Yet further, the test management resource 140 implements the analyzer resource 143 to determine a respective subject matter 223 to which the set of feedback 213 pertains. In addition to identifying that the feedback 213 pertains to subject matter 223 (such as slow download of application 151 on a communication device), the test management resource 140 produces corresponding feedback statistics 233 including information such as how many of the corresponding users 108 experiences a failure associated with the respective application 151, a particular type of failure (such as slow download) associated with application 151, the time of the failure associated with application 151, type of computer device used by the user during a failure associated with application 151, network conditions at time of failure, etc.

The test management resource 140 maps the corresponding subject matter 223 (such as word vector form of respective text-based feedback) associated with the set of feedback 213 to appropriate test case 161-1 of application 151 that addresses the identified feedback indicated by the subject matter 223. For example, in this example embodiment, the test management resource 140 identifies that the set of feedback 213 pertains to a particular topic T61-1 such as defect associated with download of customer service application 151, which is addressed by the test case 161-1 (such as test routines, set of test software instructions, testing code, testing plan, etc., used to test the identified defect).

Accordingly, embodiments herein include processing the sets of feedback to identify one or more test plans to which corresponding complaints in the feedback pertain. In one embodiment, mapping of the feedback to appropriate one or more test cases enables modification/management of same so that the one or more test cases are appropriately updated to address the identified complaints.

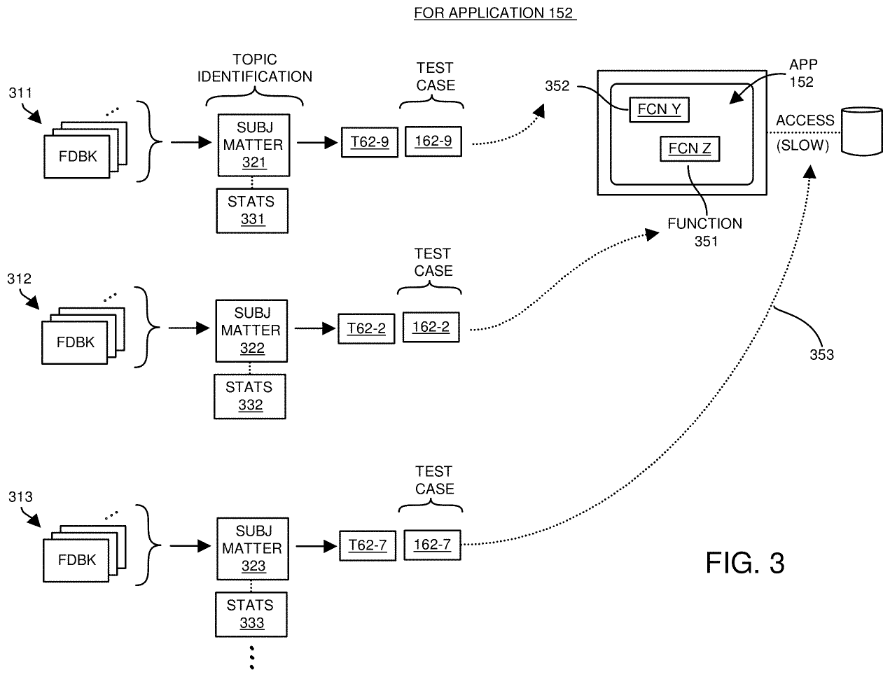

FIG. 3 is an example diagram illustrating mapping of usage feedback to corresponding test cases according to embodiments herein.

In this example embodiment, the test management resource 140 receives set of feedback 311 such as filtered feedback from multiple users providing feedback associated with customer service application 152.

As previously discussed, using text analysis, the test management resource 140 implements the analyzer resource 143 to determine a respective subject matter 321 to which the set of feedback 311 pertains.

As further shown, in this example embodiment, based on feedback 311, in addition to identifying that the set of feedback 311 pertains to subject matter 321 (a first particular topic) the test management resource 140 produces corresponding feedback statistics 331 including information such as how many of the corresponding users 108 experiences a failure associated with the respective application 152, a particular type of failure associated with application 152, the time of the failure associated with application 152, type of computer device used by the user during a failure associated with application 152, etc. Any of this information can be used as a basis to determine management of a corresponding customer service application or test plans.

In accordance with further embodiments, the test management resource 140 maps the corresponding subject matter 321 to topic T62-9 assigned to test case 162-9, which is configured to test a portion of application 152 that addresses the identified feedback indicated by the subject matter 321. In other words, assume that the subject matter 321 indicates failure of function Y (352) associated with customer service application 152. In this example embodiment, the test management resource 140 identifies that the set of feedback 311 pertains to a particular topic T62-9 (such as defect associated with function Y of the application 152) addressed by the test case 162-9 because test case 162-9 (such as test routines, set of test software instructions, testing code, testing plan, etc., used to test the identified defect) pertains to (or exists for) testing of the function Y associated with application 152.

As further shown, the test management resource 140 implements the analyzer resource 143 to determine a respective subject matter 322 to which the set of feedback 312 pertains.

Yet further in this example embodiment, in addition to identifying that the set of feedback 312 pertains to subject matter 322, based on further processing of the received set of feedback 312, the test management resource 140 produces corresponding feedback statistics 332 including information such as how many of the corresponding users 108 experiences a same failure associated with the respective application 152, a particular type of the failure associated with application 152, the time of the failure associated with application 152, type of computer device used by the user during a failure associated with application 152, etc.

In this example embodiment, the test management resource 140 maps the corresponding subject matter 322 associated with the set of feedback 312 to topic T62-2 assigned to test case 162-2 of application 152 that addresses testing of the defect (such as failure of function 351 and corresponding inability to login to the system) indicated by the subject matter 322. Thus, test case 162-2 (such as test routines, set of test software instructions, testing code, testing plan, etc., used to test the identified defect) is used to test the functionality associated with the function 351.

Yet further, the test management resource 140 implements the analyzer resource 143 to determine a respective subject matter 323 to which the set of feedback 313 pertains. In addition to identifying that the feedback 313 pertains to subject matter 323 (such as slow download of application 152 on a respective communication device), the test management resource 140 produces corresponding feedback statistics 333 including information such as how many of the corresponding users 108 experiences a failure associated with the respective application 152, a particular type of failure (such as slow download) associated with application 152, the time of the failure associated with application 152, type of computer device used by the user during a failure associated with application 152, network conditions at time of failure, etc.

The test management resource 140 maps the corresponding subject matter 323 associated with the set of feedback 313 to topic T62-7 assigned to test case 162-7 (such as test routines, set of test software instructions, testing code, testing plan, etc., used to test the identified defect), which is used to test slow access issue 353 (such as a slow download issue) associated with the customer service application 152.

Accordingly, embodiments herein include processing the sets of feedback for each multiple customer service applications to identify one or more test plans to which corresponding complaints in received feedback pertain. In one embodiment, mapping of the feedback to appropriate one or more test cases enables management and/or modification of same so that the one or more test cases are appropriately implemented, updated, etc., to address the identified complaints.

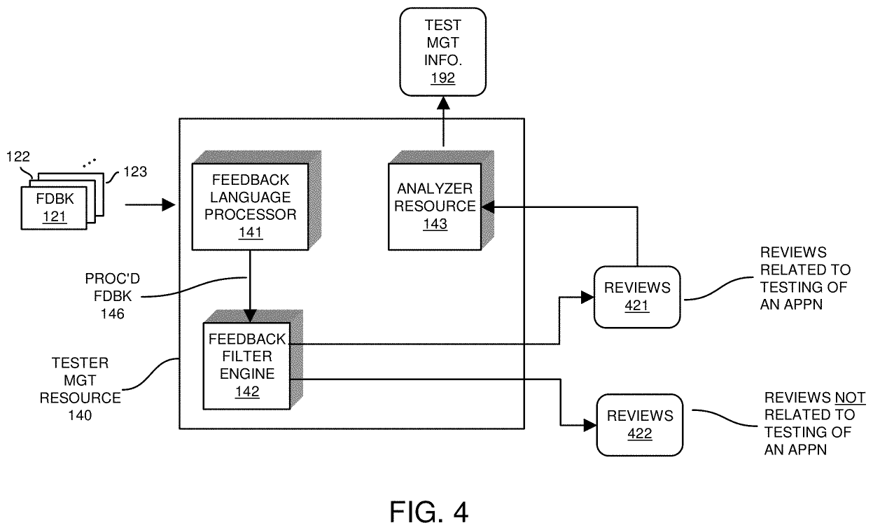

FIG. 4 is an example diagram illustrating implementation of a test management resource according to embodiments herein.

In this example embodiment, the test management resource 140 derives the test management information 192 from the feedback 121, 122, 123, etc. (such as customer service application user logs, user feedback, etc.).

More specifically, feedback language processor 141 processes the feedback 121, 122, 123, etc., into respective processed feedback 146 (such as word vectors or other suitable formatted data derived from feedback). In one embodiment, the initial processing of feedback reduces the feedback to most relevant words that indicate a topic to which the feedback most likely pertains.

Feedback filter 142 further analyzes the processed feedback 146 to identify which of multiple classes the received feedback (reviews) pertain.

For example, in one embodiment, as shown, the feedback filter 142 splits the respective reviews (and corresponding received feedback) into class of reviews 421 (first feedback) and class of reviews 422 (second feedback). In one embodiment, feedback filter 142 classifies any of the feedback pertaining to testing of a respective customer service application(s) in class of reviews 421; feedback filter 142 classifies any of the feedback pertaining to non-testing of respective customer service application(s) in class of reviews 422.

As previously discussed, via yet further processing, the analyzer resource 143 produces test management information 192 based upon the reviews (feedback 121, 122, 123, etc.) related to testing of respective customer service applications. As previously discussed, analyzer resource 143 can be configured to further identify which different test cases the feedback pertains.

Accordingly, embodiments herein include identifying which of the received feedback 121, 122, 123, etc., pertains to testing of a respective customer service application and then generating corresponding test management information 192 based on such reviews.

As previously discussed, the test management information 192 can include any suitable information in which to manage test cases. In one embodiment, test management information 192 controls test management functions associated with customer service applications such as prioritization of one or more existing or newly created test matters, further development or modification of an existing test matter, creation of a new test matter to address a newly identified customer service application defect, and so on.

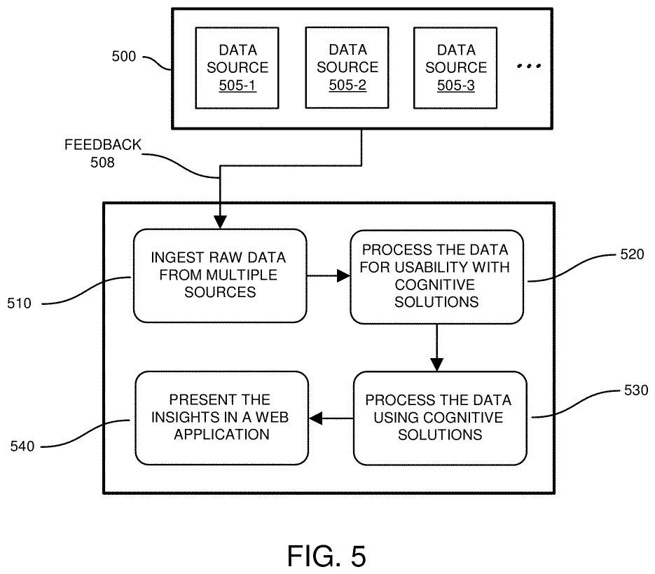

FIG. 5 is an example diagram illustrating test management operations according to embodiments herein.

In this example embodiment, the test management resource 140 receives the feedback 505 (such as including any of feedback 121, 122, . . . , 211, 212, . . . 311, 312, . . . ) from one or more data sources 505-1 (such as JIRA™ identified defects), data 505-2 (Google Play store), data source 505-3 (Apple™ App Store), etc.).

In processing operation 510, the test management resource 140 ingests corresponding raw feedback data 508 (such as text-based reviews, user log information, etc.) from multiple sources 505.

In processing operation 520, the test management resource 140 processes the feedback data for usability with cognitive solutions.

In processing operation 530, the test management resource 140 processes the data using cost cognitive solutions.

In processing operation 540, the test management resource 140 presents the test management information 192 in a web application or other platform for further analysis and/or implementation of test cases with respect to the customer service applications.

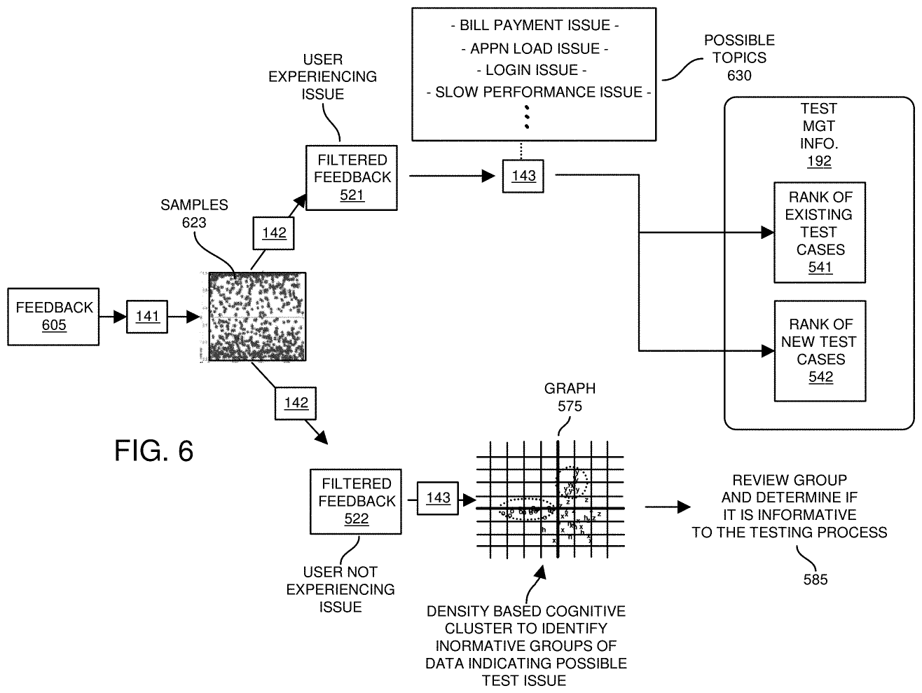

FIG. 6 is an example diagram illustrating analysis of feedback and corresponding test management operations according to embodiments herein.

As further shown in this example embodiment, feedback language processor 141 processes the feedback 605 (such as any of feedback 121, 122, . . . , 211, 212, . . . 311, 312, . . . ) received from any of one or more data sources 505-1 (such as JIRA™ identified defects), data 505-2 (Google Play store), data source 505-3 (Apple™ App Store), etc.).

In one embodiment, the feedback language processor 141 converts the received feedback 605 into different feedback samples 623 (such as word vectors useful to identify a topic to which the feedback samples 623 pertain), each of which is assigned one or more metrics depending on attributes of the respective feedback.

Using the feedback samples 623, the feedback filter engine 142 classifies the feedback as either filtered feedback 521 or filtered feedback 522.

In this example embodiment, the filtered feedback 521 represents feedback from corresponding users experiencing an issue such as a problem, shortcoming, defect, etc., in which one or more functions of a corresponding customer service application does not work properly.

Conversely, the filtered feedback 522 represents feedback from corresponding users that do not experience an issue such as a problem, shortcoming, defect, etc., associated with a known issue or defect associated with one or more functions of the customer service applications.

As further shown, and as previously discussed, the analyzer resource 143 identifies which of the different topics 630 (such as a bill payment issue, application load issue, login issue, slow application execution performance issue, etc.) to which the corresponding filtered feedback 521 pertains. Via such information, the analyzer resource 143 produces test management information 192 such as a ranking of previously existing test cases 541 associated with customer service applications, ranking of new test cases 542 or old test cases to be developed or modified to test respective attributes of corresponding customer service applications, etc.

In accordance with further example embodiments, the analyzer resource 143 processes the filtered feedback 522 to identify possible areas of interests (such as complaints specifying customer service application defects not currently known). In one embodiment, the analyzer resource 143 generates graph 572 of the different samples. The analyzer resource 143 applies density-based cognitive clustering to identify informative groups of data indicating possible issues associated with the customer service applications. Results of the analysis (such as different groupings of related samples) can be reviewed to determine if the identified clusters of related feedback pertain to or require testing of a corresponding defect associated with a respective customer service application.

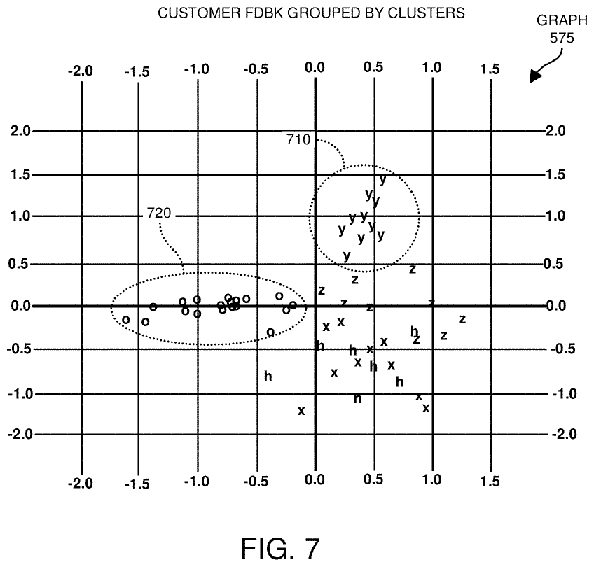

FIG. 7 is an example graph illustrating feedback grouped by cluster according to embodiments herein.

In this example embodiment, the graph 575 includes multiple clusters of sample data.

For example, the “o” samples in graph 575 represent a first set of related (or highly correlated) feedback samples; the “y” samples in graph 575 represent a second set of related (or highly correlated) feedback samples; the “h” samples in graph 575 represent a third set of related feedback samples; the “z” samples in graph 575 represent a first set of related feedback samples; and so on.

The tight cluster 710 (high density and high correlation with respect to each other) of “o” samples indicate that the corresponding feedback to which the “o” samples pertain are likely related to or indicate the same topic and/or issue.

As previously discussed, embodiments herein can include further review of respective cluster 710 to determine if such corresponding feedback (such as similar or identical negative reviews from customers of a corresponding function associated with a customer service application) warrants creation of a new test case/plan to test the corresponding function (and/or specific topic) to which the cluster 710 of “o” samples pertain. For example, the “o” samples may indicate that a bill pay function associated with customer service application 151 does not work properly for Apple (IOS) devices used to access the corresponding customer service application. In such an instance, the test management resource 140 or other suitable resource can be configured to generate test management information 192 indicating notification to a business entity that a new test case needs to be generated (or updated) for the identified defect in the corresponding customer service application.

Further in this example embodiment, the tight cluster 720 (high density and high correlation with respect to each other) of “y” samples indicate that the corresponding feedback to which the “y” samples are likely related to or indicate the same topic and/or issue. As previously discussed, embodiments herein can include further review of respective cluster 720 to determine if such corresponding feedback (such as similar or identical negative reviews from customers of a corresponding function associated with a customer service application) warrants creation of a new test case/plan to test the corresponding function (and/or specific topic) to which the cluster 720 of “y” samples pertain. For example, the “y” may indicate that a webpage of a customer service application does not work properly for a particular type of browser. In such an instance, the test management resource 140 can be configured to generate test management information 192 to provide notification of the defect to a business entity and that a new test case needs to be generated for the identified defect in the corresponding customer service application.

Other samples may not be sufficiently related to each other to indicate any particular issue associated with a customer service application in which case no new test case is opened.

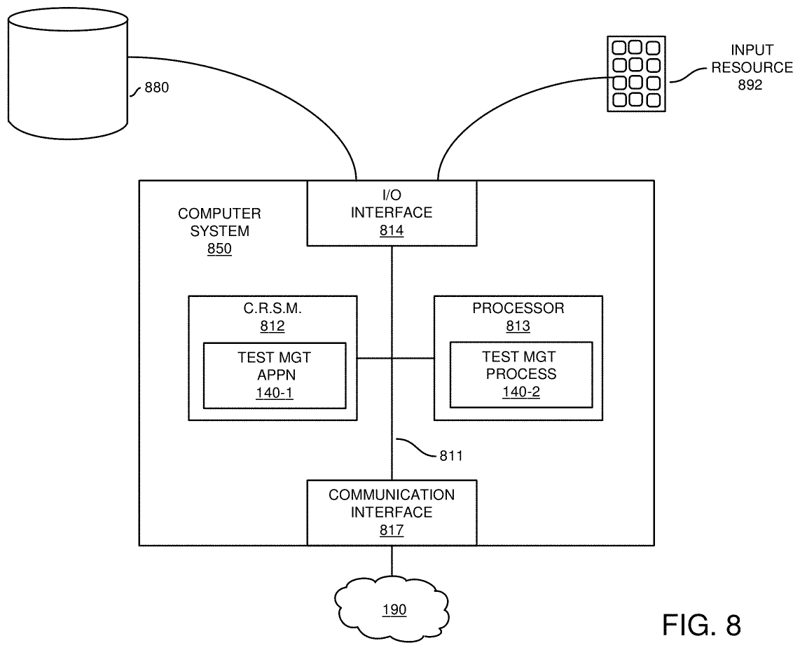

FIG. 8 is an example block diagram of a computer system for implementing any of the operations as previously discussed according to embodiments herein.

Any of the resources (such as test management resource 140, computer devices and corresponding display screens 130, the feedback language processor 141, feedback filter engine 142, analyzer resource 143, etc.) as discussed herein can be configured to include computer processor hardware and/or corresponding executable software instructions to carry out the different operations as discussed herein.

As shown, computer system 850 of the present example includes an interconnect 811 coupling computer readable storage media 812 such as a non-transitory type of media (which can be any suitable type of hardware storage medium in which digital information can be stored and retrieved), a processor 813 (computer processor hardware), I/O interface 814, and a communications interface 817.

I/O interface(s) 814 supports connectivity to repository 880 and input resource 892.

Computer readable storage medium 812 can be any hardware storage device such as memory, optical storage, hard drive, floppy disk, etc. In one embodiment, the computer readable storage medium 812 stores instructions and/or data.

As shown, computer readable storage media 812 can be encoded with test management application 140-1 (e.g., including instructions) to carry out any of the operations as discussed herein.

During operation of one embodiment, processor 813 accesses computer readable storage media 812 via the use of interconnect 811 in order to launch, run, execute, interpret or otherwise perform the instructions in test management application 140-1 stored on computer readable storage medium 812. Execution of the test management application 140-1 produces test management process 140-2 to carry out any of the operations and/or processes as discussed herein.

Those skilled in the art will understand that the computer system 850 can include other processes and/or software and hardware components, such as an operating system that controls allocation and use of hardware resources to execute test management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

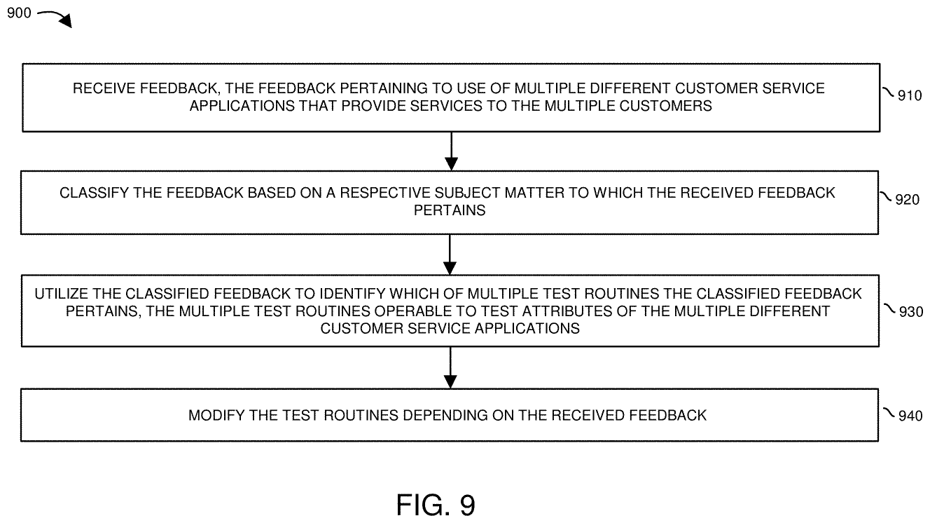

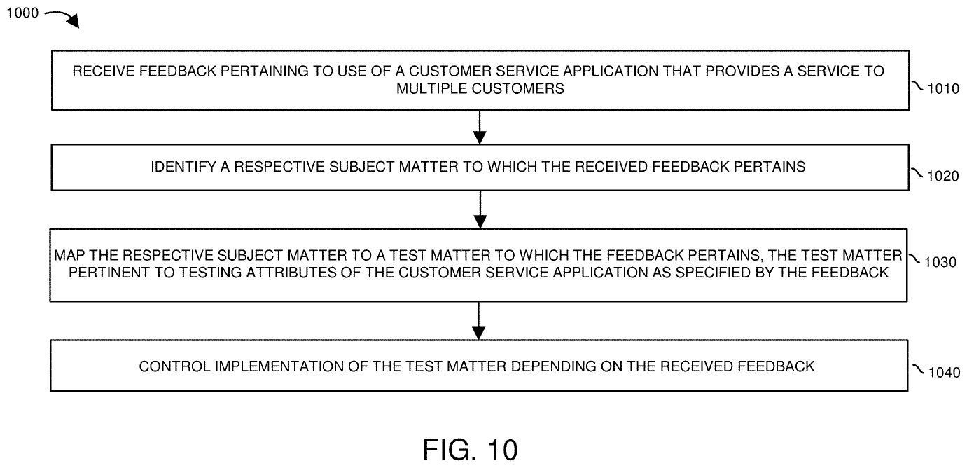

Functionality supported by the different resources will now be discussed via flowcharts in FIGS. 9, 10. and 11. Note that the steps in the flowcharts below can be executed in any suitable order.

FIG. 9 is a flowchart 900 illustrating an example method according to embodiments. Note that there will be some overlap with respect to concepts as discussed above.

In processing operation 910, the test management resource 140 receives feedback (such as feedback 121, 122, 123, 211, 212, 213, 311, 312, 313, etc.) pertaining to use of multiple different customer service applications 151, 152, 153, etc.) that provide services to the multiple customers 108.

In processing operation 920, the test management resource 140 classifies the feedback based on a respective topic to which the received feedback pertains.

In processing operation 930, the test management resource 140 utilizes the feedback to identify which of multiple test routines (such as test cases 161, 162, 163, etc.) the feedback pertains. The multiple test routines (or cases) are used (or will be used) to test attributes of the multiple different customer service applications 151, 152, 153, etc.

In processing operation 940, the test management resource 140 modifies the test routines (such as test cases) depending on the received feedback.

FIG. 10 is a flowchart 1000 illustrating an example method according to embodiments. Note that there will be some overlap with respect to concepts as discussed above.

In processing operation 1010, the test management resource 140 receives feedback pertaining to use of a particular customer service application. The particular customer service application provides customer service to multiple customers 108.

In processing operation 1020, the test management resource 140 identifies a respective topic to which the received feedback pertains.

In processing operation 1030, the test management resource 140 maps the respective topic to a test matter (such as test case) to which the feedback pertains. Assume in this example embodiment that the test matter is pertinent to testing one or more particular attributes of the customer service application as specified by the feedback.

In processing operation 1040, the test management resource 140 (or business entity overseeing the test cases) controls implementation (such as ranking, modification, implementation, etc.) of the test matter (test case) depending on the received feedback.

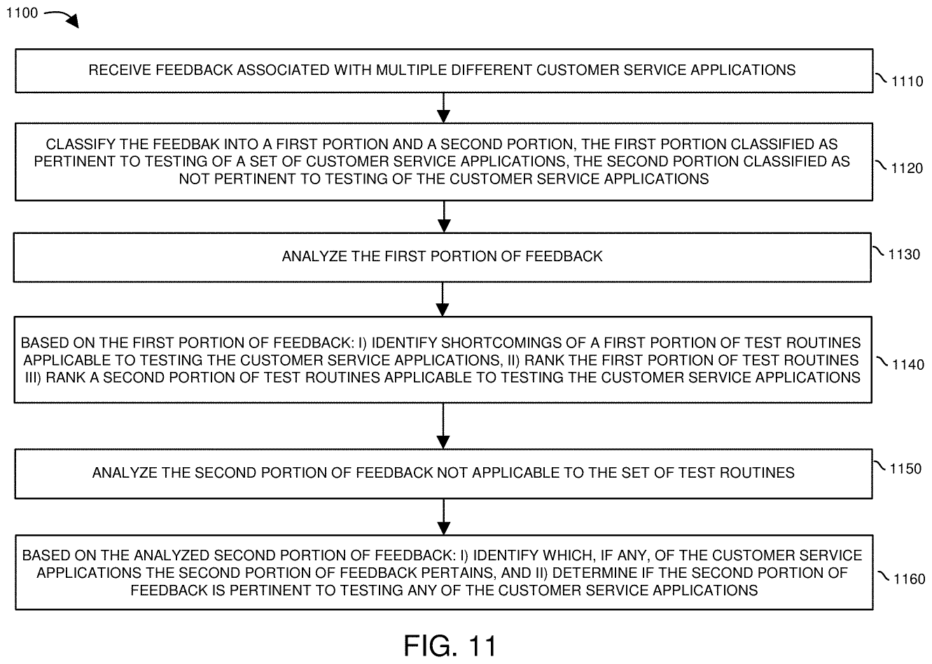

FIG. 11 is a flowchart 1100 illustrating an example method according to embodiments. Note that there will be some overlap with respect to concepts as discussed above such as in FIG. 6.

In processing operation 1110, the test management resource 140 receives feedback 605 associated with multiple different customer service applications 151, 152, 153, etc.

In processing operation 1120, the test management resource 140 classifies the feedback into a first portion (such as filtered feedback 521) and a second portion (such as filtered feedback 522). In one embodiment, the first portion 521 of feedback 605 is classified as pertinent to testing of a set of customer service applications 151, 152, 153, etc.; the second portion 522 is classified as not pertinent to testing of the customer service applications 151, 152, 153, etc.

In processing operation 1130, the test management resource 140 further analyzes the first portion 521 of feedback (pertaining to testing of the applications). In processing operation 1140, based on the first portion 521 of feedback, the test management resource 140: i) identifies shortcomings of a first portion 541 of test routines applicable to testing the customer service applications, ii) ranks the first portion 541 of existing test routines, and iii) ranks a second portion of test routines (such as new test cases 542) applicable to testing the customer service applications.

In processing operation 1150, the test management resource 140 analyzes the second portion 522 of feedback not applicable to the set of test routines.

In processing operation 1160, based on the analyzed second portion 522 of feedback the test management resource 140: i) identifies which, if any, of the customer service applications 151, 152, 153, etc., the second portion of feedback pertains, and ii) determines if the second portion 522 of feedback is pertinent to testing any of these customer service applications.

Note again that techniques herein are well suited for providing higher quality services to one or more customers via better testing management of one or more customer service applications. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving feedback pertaining to use of multiple different customer service applications that provide services to the multiple customers;
classifying the feedback based on a respective topic to which the received feedback pertains;
utilizing the respective topic to identify which of multiple test routines the classified feedback pertains, the multiple test routines operable to test attributes of the multiple different customer service applications; and
producing test management information in accordance with the received feedback.

2. The method as in claim 1, wherein the feedback is received from the multiple customers, the feedback specifying defects associated with the multiple different customer service applications.

3. The method as in claim 1, wherein the feedback is received from failure logs associated with the multiple customers using the customer service applications.

4. The method as in claim 1 further comprising:
converting the received customer feedback into word vector feedback; and
via the word vector feedback, classifying the feedback based on the respective topic.

5. The method as in claim 1, wherein receiving the customer feedback includes:
receiving first feedback, the first feedback pertinent to a first test routine applicable to testing a first customer service application of the multiple different customer service applications; and
receiving second feedback, the second feedback pertinent to a second test routine applicable to testing a second customer service application of the multiple different customer service applications.

6. The method as in claim 5, wherein producing the test management information in accordance with the received feedback includes:
ranking an order of modifying the first test routine and the second test routine depending on how many of the multiple customers indicate a problem associated with the first customer service application and how many of the multiple customers indicate a problem associated with the second customer service application.

7. The method as in claim 1, wherein the feedback indicates functions of the multiple customer service applications that do not operate properly.

8. The method as in claim 1, wherein the feedback includes negative reviews from users using the multiple different customer service applications.

9. The method as in claim 1 further comprising:
receiving the feedback from the multiple customers, the feedback pertaining to use of the multiple different customer service applications, which provide services to the multiple customers over respective network connections; and
wherein utilizing the respective topic to identify which of multiple test routines the classified feedback pertains includes: mapping the respective topic to a corresponding test routine operable to test a function of a customer service application as specified by the respective topic.

10. The method as in claim 9, wherein producing the test management information in accordance with the received feedback includes:
scheduling implementation of the corresponding test routine based on an amount of the feedback pertaining to the respective topic to which the corresponding test routine pertains.

11. The method as in claim 1, wherein the multiple customers include users of a social network, the method further comprising:
receiving at least a portion of the feedback from messages communicated between the users in the social network, the messages pertaining to use of the multiple different customer service applications.

12. The method as in claim 1 further comprising:
receiving input from the multiple customers, the input including text-based reviews of the multiple different customer service applications; and
filtering the text-based reviews to produce the feedback.

13. A system comprising:
test management hardware operable to:
receive feedback pertaining to use of multiple different customer service applications that provide services to the multiple different customers;
classify the feedback based on a respective topic to which the received feedback pertains;
utilize the respective topic to identify which of multiple test routines the classified feedback pertains, the multiple test routines operable to test attributes of the multiple different customer service applications; and
produce test management information in accordance with the received feedback.

14. The system as in claim 13, wherein the feedback is received from the multiple customers, the feedback specifying a failure associated with the multiple different customer service applications.

15. The system as in claim 13, wherein the feedback is received from failure logs associated with the multiple customers using the customer service applications.

16. The system as in claim 13, wherein the test management hardware is further operable to:
convert the received customer feedback into word vector feedback; and
via the word vector feedback, map the feedback to a respective topic to which the feedback pertains.

17. The system as in claim 13, wherein the test management hardware is further operable to:
receive first feedback, the first feedback pertinent to a first test routine applicable to testing a first customer service application of the multiple different customer service applications; and
receive second feedback, the second feedback pertinent to a second test routine applicable to testing a second customer service application of the multiple different customer service applications.

18. The system as in claim 17, wherein the test management hardware is further operable to:
rank an order of modifying the first test routine and the second test routine depending on how many of the multiple customers indicate a fault associated with the first application and how many of the multiple customers indicate a fault associated with the second application.

19. The system as in claim 13, wherein the feedback indicates attributes of the multiple customer service applications that do not operate properly.

20. The system as in claim 13, wherein the feedback represents negative reviews from users using the multiple different customer service applications.

21. The system as in claim 13, wherein the test management hardware is further operable to:
receive the feedback from the multiple customers; and
map the respective topic to a corresponding test routine operable to test a function of a customer service application as specified by the respective topic.

22. The system as in claim 21, wherein the test management hardware is further operable to:
schedule an update to the corresponding test routine based on an amount of the feedback pertaining to the respective topic to which the corresponding test routine pertains.

23. The system as in claim 13, wherein the multiple customers include users of a social network, the test management hardware further operable to:
receive at least a portion of the feedback from messages communicated between users in a social network, the messages pertaining to use of the multiple different customer service applications.

24. The system as in claim 13, wherein the test management hardware is further operable to:
receive input from the multiple customers, the input including text-based reviews of the multiple different customer service applications; and
filter the text-based reviews to produce the feedback.

25. A method comprising:
receiving feedback pertaining to use of a customer service application, the customer service application providing customer service to multiple customers;
identifying a respective topic to which the received feedback pertains;
mapping the respective topic to a test matter to which the feedback pertains, the test matter pertinent to testing attributes of the customer service application as specified by the feedback; and
producing test management information in accordance with the received feedback.

26. The method as in claim 25 further comprising:
converting the received customer feedback into word vector feedback; and
via the word vector feedback, mapping the feedback to the respective topic to which the feedback pertains.

27. The method as in claim 25, wherein receiving the customer feedback includes:
receiving first feedback, the first feedback pertinent to a first test routine applicable to testing a first customer service application of the multiple different customer service applications; and
receiving second feedback, the second feedback pertinent to a second test routine applicable to testing a second customer service application of the multiple different customer service applications.

28. The method as in claim 27, wherein producing test management information includes:
ranking an order of modifying the first test routine and the second test routine depending on how many of the multiple customers indicate a fault associated with the first configuration setting and how many of the multiple customers indicate a fault associated with the second customer service application.

29. The method as in claim 25, wherein the feedback represents negative reviews from users using the multiple different customer service applications.

30. Computer-readable storage hardware having instructions stored thereon, the instructions, when carried out by computer processor hardware, cause the computer processor hardware to:
receive feedback, the feedback pertaining to use of multiple different customer service applications that provide services to the multiple customers;
classify the feedback based on a respective topic to which the received feedback pertains;
utilize the classified feedback to identify which of multiple test routines the classified feedback pertains, the multiple test routines operable to test attributes of the multiple different customer service applications; and
produce test management information in accordance with the received feedback.
